(19) United States
(12) Patent Application Publication
(10) Pub. No.: US 2025/0384653 A1
(43) Pub. Date: Dec. 18, 2025

(54) IMAGE BACKGROUND BLURRING METHOD AND DEVICE

(71) Applicant: SigmaStar Technology Ltd., Xiamen (CN)

(72) Inventors: Yin-Qiu LIU, Chengdu (CN); Xiao-Feng LI, Chengdu (CN); Jian-Bo PAN, Chengdu (CN)

(21) Appl. No.: 18/966,284

(22) Filed: Dec. 3, 2024

(30) Foreign Application Priority Data
Jun. 17, 2024 (CN) 202410777352.1

(51) Int. Cl. G06V 10/36; G06T 3/40; G06V 10/26; G06V 20/70

(52) U.S. Cl. CPC G06V 10/36; G06T 3/40; G06V 10/26; G06V 20/70

(57) ABSTRACT

An image background blurring method includes: obtaining an image to be blurred; performing identification processing on the image by an image semantic segmentation model in response to a target object confirmation instruction to obtain a confidence map indicating a target region of a target object in the image; generating a background image of the image according to the confidence map; performing blur processing on the background image in response to a blurring instruction including a blurring degree to obtain a blurred background image, wherein the blur processing includes determining a reduction factor according to the blurring degree and performing reduction processing on the background image according to the reduction factor; and merging the blurred background image and the image according to the confidence map to obtain a target image. The present application enhances blur processing efficiency by reducing a data computation amount during the blur processing.

This application claims the benefit of China application Serial No. CN202410777352.1, filed on Jun. 17, 2024, the subject matter of which is incorporated herein by reference.

### BACKGROUND OF THE INVENTION

### Field of the Invention

The present application relates to the technical field of image processing, and more particularly to an image background blurring method and device.

### Description of the Related Art

Background blurring is an image processing technique that performs blur processing on a background region of an image in order to emphasize a subject of the image, for example, blurring a background region of an image using Gaussian filtering. However, when filter and blur processing is performed on a background region of an image using Gaussian filtering, a large-size filter kernel is usually directly used to filter and blur the background image. A data computation amount of the filter processing based on such large-size filter kernel is rather large, leading to degraded efficiency of the background blur processing.

### SUMMARY OF THE INVENTION

It is an object of the present application to provide an image background blurring method and device so improve the issues above.

In some embodiments, an image background blurring method includes: obtaining an image to be blurred; performing identification processing on the image by an image semantic segmentation model in response to a target object confirmation instruction to obtain a confidence map that indicates a target region of a target object in the image; generating a background image of the image according to the confidence map; performing blur processing on the background image in response to a blurring instruction to obtain a blurred background image, wherein the blurring instruction comprises a blurring degree, and the blur processing comprises determining a reduction factor according to the blurring degree and performing reduction processing on the background image according to the reduction factor; and merging the blurred background image and the image according to the confidence map to obtain a target image.

In some embodiments, an image background blurring device includes an image identification circuit, an image filling circuit, an image blurring circuit and a merging circuit. The image identification circuit obtains an image to be blurred from a memory, and performs identification processing on the image by an image semantic segmentation model in response to a target object identification request to obtain a confidence map that indicates a target region of a target object in the image. The image filling circuit generates a background image of the image according to the confidence map. The image blurring circuit performs blur processing on the background image in response to a blurring instruction to obtain a blurred background image, wherein the blurring instruction includes a blurring degree, and the blur processing includes determining a reduction factor according to the blurring degree and performing reduction processing on the background image according to the reduction factor. The image merging circuit merges the blurred background image and the image according to the confidence map to obtain a target image.

The image background blurring method and device of the present application first generate a background image according to a confidence map of an image, then determine a reduction factor for the background image according to an image background blurring degree and accordingly reduces the background image when blur processing is performed on the background image, and performs filter processing on the reduced background image by using a small-size filter mask. Thus, both the data computation amount and complexities during the image background blur processing are decreased, hence improving the efficiency of the image background blur processing.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of function modules of an image background blurring device according to a first embodiment of the present application;

FIG. 2 is a flowchart of an image background blurring method according to the first embodiment of the present application;

FIG. 3 is a schematic diagram of a confidence map according to the first embodiment of the present application;

FIG. 4A is a schematic diagram of an image to be blurred according to the first embodiment of the present application;

FIG. 4B is a schematic diagram of a background image according to the first embodiment of the present application;

FIG. 5 is a schematic diagram of function modules of an image blurring circuit 203 of an image background blurring device of the present application; and

FIG. 6 is a flowchart of step S204 of an image background blurring method according to the first embodiment of the present application.

### DETAILED DESCRIPTION OF THE INVENTION

The technical terms given in the detailed description below are used with reference to conventional terms in the art. If some of the terms are described or defined in the present application, these terms are to be interpreted in accordance with the description and definitions given in the present application.

The disclosure of the present application includes an image background blurring method and device. A part or all of the image background blurring method of the present application can be in a form of software and/or firmware, and can be performed by the image background blurring device of the present disclosure.

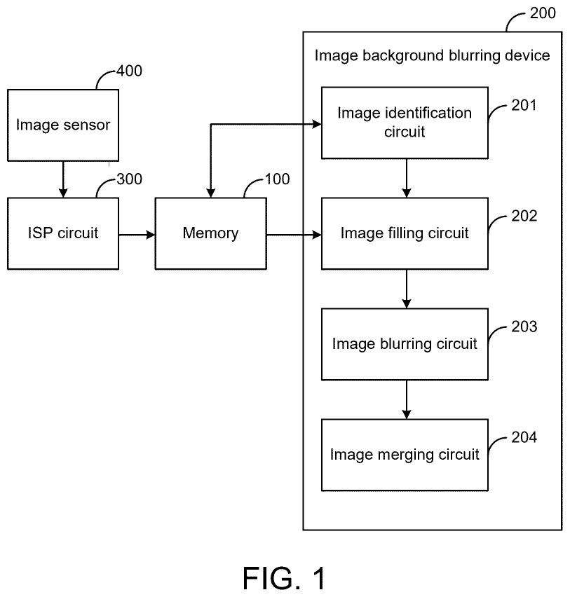

FIG. 1 shows a schematic diagram of function modules of an image background blurring device of the present application. The image background blurring device 200 is connected to a memory 100, and includes an image identification circuit 201, an image filling circuit 202, an image blurring circuit 203 and an image merging circuit 204. The memory 100 is a dynamic random access memory (DRAM), and has an image to be blurred stored therein. The image to be blurred stored in the memory 100 is an image obtained by an image sensor 400. The image sensor 400 may be a camera. In this embodiment, the image obtained by the image sensor 400 may be processed by an image signal processing (ISP) circuit 300 and then stored into the memory 100; that is, the image to be blurred is an image of an original image obtained by the image sensor 400 and undergone processing by the ISP circuit 300. The ISP circuit 300 may perform processes such as image enhancement, color distortion correction, noise reduction and white balance on the original image obtained by the image sensor 400 so as to obtain the image to be blurred. In other embodiments, the ISP circuit 300 may be omitted. In some embodiments, the image obtained by the image sensor 400 includes depth of field data, and thus the image to be blurred includes a depth of field parameter.

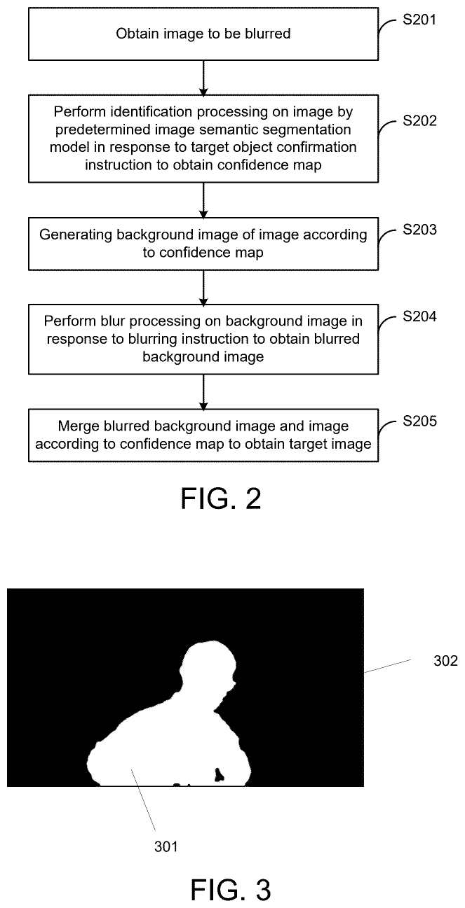

The circuits above of the image background blurring device 200 are individually described in detail in combination with FIG. 2 below.

Refer to FIG. 2 showing a flowchart of an image background blurring method provided according to a first embodiment of the embodiments of the present application. The image background blurring method includes the following steps.

In step S201, the image identification circuit 201 obtains the image to be blurred from the memory 100.

The memory 100 includes multiple buffers, the ISP circuit 300 stores in advance the image to be blurred in a predetermined bluffer, and the image identification circuit 201 reads the image to be blurred from the predetermined buffer in response to a user operation such as an image preview operation.

In step S202, the image identification circuit 201 performs identification processing on an image by a predetermined image semantic segmentation model in response to a target object confirmation instruction to obtain a confidence map, which indicates a location region of the target object in the image.

In one embodiment, the target object confirmation instruction may be a user-input command for identifying a predetermined object in the image, for example, a user inputs a portrait via an input box so as to generate an instruction for confirming a target object which is the portrait. In one embodiment, the image semantic segmentation model includes a deep convolutional neural network, extracts a feature map of the target object from the image by the deep convolutional neural network, and generates the confidence map of the target object according to the feature map. The confidence map indicates a location region of the target object in the image.

Refer to FIG. 3 showing a schematic diagram of a confidence map according to the first embodiment of the present application. The confidence map includes a location region 301 (to be referred to as a target object region 301) where the target object is located and a location region 302 (to be referred to as a non-target object region 302) without the target object in the image. In one embodiment, the image identification circuit 201 further performs binarization processing on the confidence map to label the target objection region 301 by a first value (for example, 0) and label the non-target object region 302 by a second value (for example, 1). It should be understood that, the image to be blurred may include multiple objects according to actual conditions, and the confidence map may include multiple target object regions 301 and one non-target object region 302 based on the number of target objects included in the target object identification request.

The image identification circuit 201 further stores the confidence map obtained into the memory 100.

In step S203, the image filling circuit 202 generates a background image of the image according to the confidence map.

The image filling circuit 202 determines the target region and a background region according to the confidence map. More specifically, the image filling circuit 202 determines the target region of the image according to the target object region 301 of the confidence map, and determines the background region of the image according to the non-target object region 302 of the confidence map. It should be understood that, the image filling circuit 201 is able to determine the target region and the background region of the image according to the target object region of the confidence map; that is, a pixel region of the image corresponding to the target object region of the confidence map is the target region of the image, and a pixel region of the image corresponding to the non-target object region of the confidence map is the background region of the image.

In one embodiment, the image filling circuit 202 further performs filling on pixel values of pixels in the target region by pixel values of pixels in the background region to generate a background image of the image. By substituting the pixel values of the pixels in the background region for the pixel values of the pixels in the target region to generate the background image of the image, a region in the background image generated corresponding the target region does not include pixel values of the pixels in the target region, hence preventing the pixel values of the pixels in the target region from being brought into the background image and preventing the occurrence of undesirable effects after the image background blur processing, for example, abnormalities such as halos and burrs.

In some embodiments, the pixel values of the pixels for filling the target region may be pixel values of pixels in the background region adjacent to the target region, such that the pixel values in the target region in the filled background image and the pixel values in the background region adjacent to the target region are the same. Thus, automatically induced noise caused by a larger difference between image pixels for filling the target region and background pixels in the background region adjacent to the target region can be prevented. More specifically, the image identification circuit 201 may determine a border frame of the target region according to the confidence map, wherein the border frame is a frame formed by connecting most peripheral pixels of the target region of the image. The image filling circuit 202 determines the background region and the pixel values of the adjacent pixels according to the border frame, substitutes the determined pixel values of the pixels for the pixel values of the pixels in the target region to implement filling of the target region of the image, and generates the background image of the image after the filling is completed. As such, it is ensured that the pixel values filled to the target region and the pixel values of the background region adjacent to the target region are the same, preventing induced noise into the generated background image.

In some embodiments, the image filling circuit 202 may fill each row of foreground pixels in the target area in a manner of substitution by one row after another with background pixel values of the adjacent background region. When substitution by one row after another is used, the image identification circuit 201 further determines each target pixel row in the target region according to the border frame, wherein each target pixel row includes multiple target pixels, and determines a start point, a midpoint and an end point of each target pixel row. When filling the target region, the image filling circuit 202 substitutes a pixel value of a pixel in the background region adjacent to the start point for pixel values of pixels from the start point to the midpoint of the target pixel row, and substitutes a pixel value of a pixel in the background region adjacent to the end point for pixel values of pixels from the midpoint to the end point of the target pixel row.

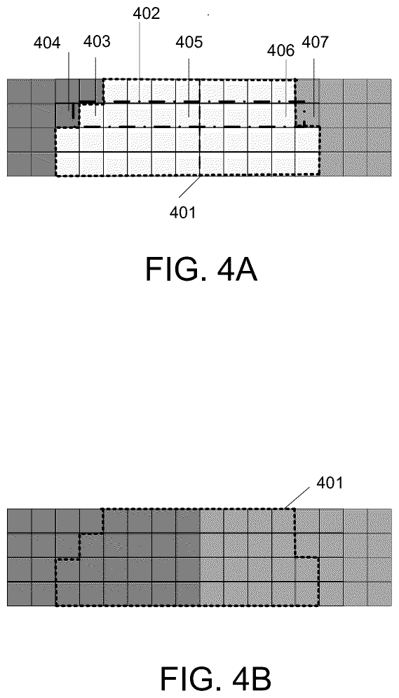

Referring to FIG. 4A and FIG. 4B, FIG. 4A shows a schematic diagram of an image to be blurred, and FIG. 4B shows a background image of the image in FIG. 4A. As shown in FIG. 4A, the image filling circuit 202 determines, according to the confidence map, a border frame 401 of the target region in the image to be blurred, wherein a region inside the border frame 401 is the target region of the image to be blurred, and a region outside the border frame 401 is the background region of the image to be blurred. The target region inside the border frame 401 includes multiple target pixel rows, each of which including multiple target pixels. The image filling circuit 202 determines and records the start point, the midpoint and the end point of each target pixel row within the target region one row after another, substitutes the pixel value of the pixel in the background region left adjacent to the start point for the pixel values of the pixels from the start point to the midpoint of each target pixel row, and substitutes the pixel value of the pixel in the background region right adjacent to the end point for the pixel values of the pixels from the midpoint to the end point of each target pixel row. Taking a second foreground pixel row 402 shown in FIG. 4A for example, a start point 403, a midpoint 405 and an end point 406 of the second foreground pixel row 402 are first determined, the pixel value of a pixel 404 in the background region adjacent to the start point 403 is used to substitute for the pixel values of multiple pixels from the start point 403 to the midpoint 405 of the second foreground pixel row 402, and then the pixel value of a pixel 407 in the background region adjacent to the end point 406 is used to substitute for the pixel values of multiple pixels from the midpoint 405 to the end point 406 of the second foreground pixel row 402. On the basis of the same operation, the substitution for the pixel values of the pixels in each of the foreground pixel rows within the border frame 401 is completed to obtain the background image of the image to be blurred (as shown in FIG. 4B). The background image includes only the pixel values of the background region of the image but does not include any pixel values of the target region of the image, and thus the pixel values of the target region of the image can be prevented from being induced and hence from generating noise during the blur processing on the background image.

In step S204, the image blurring circuit 203 performs blur processing on the background image in response to a blurring instruction to obtain a blurred background image.

In embodiments of the present application, the blurring instruction includes a blurring degree. The blur processing performed by the image blurring circuit 203 on the background image includes determining a reduction factor for the background image according to the blurring degree, and performing reduction processing on the background image according to the reduction factor. Thus, the reduction factor for the reduction processing of the background image is determined by the blurring degree. More specifically, the reduction factor correspondingly decreases as the blurring degree of the background image increases. In some embodiments, the reduction factor is a small value less than 1, for example, 0.2.

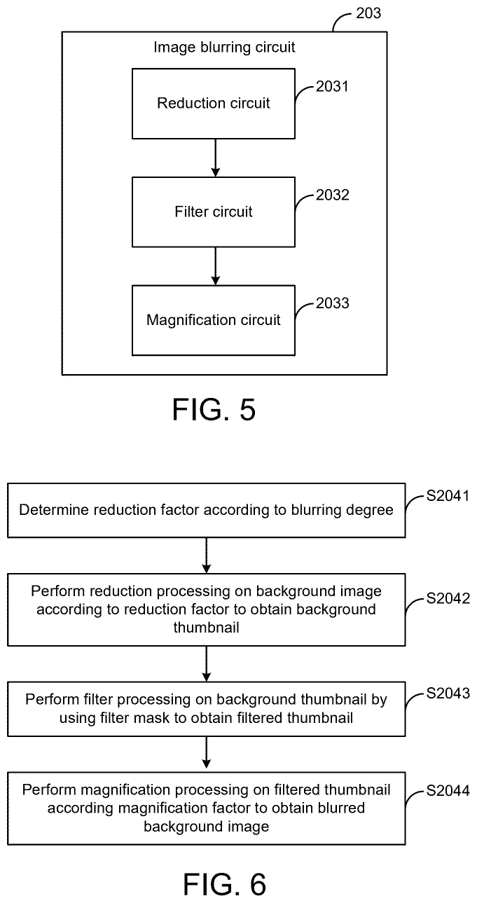

It is generally to a person of ordinary skill in the art that, image reduction processing implies that the number of pixels is decreased, and this causes blurring or completely disappearance of image information such as details and texture, and more particularly when the reduction ratio is rather large (that is, the reduction factor is rather small). The image blurring circuit 203 is described in detail in combination with FIG. 5 and FIG. 6 below. Referring to FIG. 5 showing a schematic diagram of function modules of the blurring circuit 203 according to an embodiment, the blurring circuit 203 includes a reduction circuit 2031, a filter circuit 2032 and a magnification circuit 2033.

Refer to FIG. 6 showing a detailed flowchart of step S204 of one embodiment of the present application, that is, a detailed process of the background image blur processing. Step S204 includes the following sub-steps.

In step S2041, the reduction circuit 2031 determines a corresponding reduction factor according to a blurring degree. In step S2042, reduction processing is performed on the background image according to the reduction factor to obtain a background thumbnail.

In some embodiments, the reduction circuit 2031 obtains user-defined blurring degree data for the background image and accordingly obtains a corresponding reduction factor. More specifically, the reduction circuit 2031 obtains a blurring degree of the image in response to a user input operation, for example, a user may input blurring degree data for the image in an input box provided by an input device. Thus, the blurring degree data may be set according to user requirements.

In another embodiment, when the image to be blurred is an image with depth of field data obtained by a depth of field camera, the reduction circuit 2031 obtains the depth of field data from the image upon receiving the blurring instruction and accordingly determines the blurring degree. More specifically, the reduction circuit 2031 determines background depth of field data of the background region according to the background region of the image and the obtained depth of field data, and accordingly determines the blurring degree. Thus, the blurring degree is determined by the background depth of field data. In one embodiment of the present application, the reduction circuit 2031 further determines the corresponding reduction factor according to the background depth of field data, and then performs reduction processing on the background image according to the reduction factor to obtain the background thumbnail. More specifically, when the background depth of field data includes only one data value, the reduction circuit 2031 determines the reduction factor according to the data value; when the background depth of field data includes multiple data values, the reduction circuit 2031 determines the reduction factor based on the multiple data values, for example, determining the reduction factor for the background image according to a maximum value of the multiple data values or a mean value of the multiple data values. Moreover, the reduction factor for the background image decreases as the value of the background depth of field data increases, and distortion of the image further aggravates as the background image is reduced to a greater degree.

In other words, the reduction circuit 2031 may determine the blurring degree according to the background depth of field data of the image, and perform reduction processing on the background image according to the determined reduction factor for the background image according to the blurring degree. Thus, the blurring degree of the background image is determined by the depth of field data included in the image itself (and more particularly the background depth of field data), hence realizing the reduction processing of the background image in a smart manner. The reduction circuit 2031 may be perform the reduction processing on the background image by using existing interpolation algorithm, and related details are omitted herein. The reduction circuit 2031 further stores the background thumbnail into the memory 100.

In step S2043, the filter circuit 2032 performs filter processing on the background thumbnail by using a filter mask to obtain a filtered thumbnail.

The filter processing performed by the filter circuit 2032 on the background thumbnail may further remove image details in the background image so as to obtain a background image with blurred effects. More specifically, the filter mask may be in dimensions such as 3*3, 3*5 or 5*5. Compared to the prior art in which a background image is blurred by performing filter processing on the background image, the present application performs filter processing on the background thumbnail. Since the number of pixels of the background thumbnail is less than that of the background image, a filter mask having smaller dimensions, for example, 3*3, can be selected for the filter processing on the background thumbnail. Thus, both a data computation amount and complexities for filter processing of the background thumbnail are lower than those of a background image, hence better promoting hardware implementation for filter processing. The filter circuit 2032 may perform filter processing on the background thumbnail by further using a Gaussian filter or a mean filter, and store the filtered thumbnail into the memory 100.

In step S2044, the magnification circuit 2033 performs magnification processing on the filtered thumbnail according to a magnification factor to obtain the blurred background image.

More specifically, the magnification circuit 2033 may determine the magnification factor of the blurred background image according to the blurring degree of the image or according to the reduction factor, and magnify the blurred background image by the magnification factor to the size of the image to be blurred. The magnification factor of the blurred background image and the reduction factor of the background are reciprocals of each other; for example, the reduction factor is ⅓, and the corresponding magnification factor is 3. Thus, sizes of the blurred background image and the image to be blurred are kept consistent, so as to ensure that the blurred background and the image to be blurred can be correctly merged. The magnification circuit 2033 further stores the blurred background image into the memory 100. The reduction circuit 2031 and the magnification circuit 2033 adopt the same interpolation algorithm, including, for example but not limited to, nearest neighbor interpolation, bilinear interpolation, bicubic interpolation, area interpolation, Lanczos interpolation or polyphase interpolation, to reduce and magnify images. In step S205, the image merging circuit 204 merges the blurred background image and the image according to the confidence map to obtain a target image.

In some embodiments, according to the confidence map, the blurred background image, and a corresponding pixel and a pixel value thereof of the image to be blurred, the merging circuit 204 determines a corresponding target pixel and a pixel value thereof in the target image. More specifically, the merging circuit 204 may use an existing alpha merging or pyramid merging algorithm to merge by one pixel after another the blurred background image and the image to be blurred. As an example, the merging circuit 204 obtains the target image according to the equation below when the alpha merging algorithm is used:

Output(x,y)=(CM(x,y)×OI(x,y)+(255−CM(x,y))×BI(x,y))/255

In the equation above, Output(x,y) represents a pixel of the target image, CM(x,y) represents a pixel of the confidence map (ConfidenceMap), BI(x,y) represents a pixel of the blurred background image (BlurredImage), and OI(x,y) represents a pixel of the image to be blurred (OriginalImage).

While the present application has been described by way of example and in terms of the preferred embodiments, it is to be understood that the disclosure is not limited thereto. Various modifications may be made to the technical features of the present application by a person skilled in the art on the basis of the explicit or implicit disclosures of the present application. The scope of the appended claims of the present application therefore should be accorded with the broadest interpretation so as to encompass all such modifications.

What is claimed is:

1. An image background blurring method, comprising:
obtaining an image to be blurred;
performing identification processing on the image by an image semantic segmentation model in response to a target object confirmation instruction to obtain a confidence map that indicates a target region of a target object in the image;
generating a background image of the image according to the confidence map;
performing blur processing on the background image in response to a blurring instruction to obtain a blurred background image, wherein the blurring instruction comprises a blurring degree, and the blur processing comprises determining a reduction factor according to the blurring degree and performing reduction processing on the background image according to the reduction factor; and
merging the blurred background image and the image according to the confidence map to obtain a target image.

2. The image background blurring method according to claim 1, wherein the blur processing comprises:
determining the reduction factor according to the blurring degree, wherein the reduction factor decreases as the blurring degree increases;
performing reduction processing on the background image according to the reduction factor to obtain a background thumbnail;
performing filter processing on the background thumbnail by using a filter mask to obtain a filtered thumbnail; and
performing magnification processing on the filtered thumbnail according to a magnification factor to obtain the blurred background image, wherein the magnification factor and the reduction factor are reciprocals of each other.

3. The image background blurring method according to claim 1, wherein the generating of the background image of the image according to the confidence map comprises:
determining a background region of the image according to the confidence map; and
substituting a pixel value of a pixel in the background region for a pixel value of a pixel in the target region to generate the background image.

4. The image background blurring method according to claim 1, wherein the generating of the background image of the image according to the confidence map comprises:
determining a border frame of the target region according to the confidence map;
determining a pixel in a background adjacent to the target region according to the border frame; and
substituting a pixel value of the determined pixel for a pixel value of a pixel in the target region to generate the background image.

5. The image background blurring method according to claim 4, further comprising:
determining each target pixel row in the target region according to the border frame, wherein the each target pixel row comprises a plurality of target pixels;
determining a start point, a midpoint and an end point of the each target pixel row;
wherein the substituting of a pixel value of the determined pixel for a pixel value of a pixel in the target region comprises:
for the each target pixel row, substituting a pixel value of a pixel in the background region adjacent to the start point for pixel values of pixels from the start point to the midpoint of the each target pixel row; and
substituting a pixel value of a pixel in the background region adjacent to the end point for pixel values of pixels from the midpoint to the end point of the each target pixel row.

6. The image background blurring method according to claim 1, wherein the image to be blurred comprises depth of field data; and the performing of blur processing on the background image in response to the blurring instruction to obtain the blurred background image comprises:
determining a background region of the image according to the confidence map, and determining background depth of field data of the background region according to the depth of field data; and
determining the blurring degree according to the background depth of field data.

7. An image background blurring device, comprising:
an image identification circuit, obtaining an image to be blurred from a memory, and performing identification processing on the image by an image semantic segmentation model in response to a target object identification request to obtain a confidence map that indicates a target region of a target object in the image;
an image filling circuit, generating a background image of the image according to the confidence map;
an image blurring circuit, performing blur processing on the background image in response to a blurring instruction to obtain a blurred background image, wherein the blurring instruction comprises a blurring degree, and the blur processing comprises determining a reduction factor according to the blurring degree and performing reduction processing on the background image according to the reduction factor; and
an image merging circuit, merging the blurred background image and the image according to the confidence map to obtain a target image.

8. The image background blurring device according to claim 7, wherein the image blurring circuit comprises:
a reduction circuit, determining the reduction factor according to the blurring degree, and reducing the background image according to the reduction factor to obtain a background thumbnail, wherein the reduction factor decreases as the blurring degree increases;
a filter circuit, performing filter processing on the background thumbnail by using a filter mask to obtain a filtered thumbnail; and
a magnification circuit, performing magnification processing on the filtered thumbnail according to a magnification factor to obtain the blurred background image, wherein the magnification factor and the reduction factor are reciprocals of each other.

9. The image background blurring device according to claim 7, wherein the filling circuit determines a background region of the image according to the confidence map, and substitutes a pixel value of a pixel in the background region for a pixel value of a pixel in the target region to generate the background image.

10. The image background blurring device according to claim 7, wherein the filling circuit determines a border frame of the target region according to the confidence map, determines a pixel in a background region adjacent to the target region according to the border frame, and substitutes a pixel value of the determined pixel for a pixel value of a pixel in the target region to generate the background image.
